(19) United States
(12) Patent Application Publication
(10) Pub. No.: US 2008/0281022 A1
(43) Pub. Date: Nov. 13, 2008

(54) Metallocene-catalyzed polyolefins in wax formulations and their use for the precision casting/lost wax process

(75) Inventors: Rainer Fell, Gerstophen (DE); Hermann Diem, Wehringen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/151,837

(22) Filed: May 9, 2008

(30) Foreign Application Priority Data
May 11, 2007 (DE) 10 2007 022 118.7

(51) Int. Cl. C08L 91/06; C08K 5/01; C08F 210/00

(52) U.S. Cl. 524/62; 526/348; 524/570

(57) ABSTRACT

The invention relates to a wax formulation comprising
a.) a wax powder or a wax powder mixture having a melting point above 120° C. as filler and
b.) a base formulation having a melting point below 100° C.

The wax formulations are used, in particular, for the precision casting process.

The present invention relates to wax formulations comprising metallocene-catalyzed polyolefins for use in the precision casting process/lost wax process.

The precision casting process, also known under the name “lost wax” process, has been used for centuries. In the precision casting process, a refractory casting mold is built around the wax model. After construction and drying, the casting mold is heated so that the wax melts and runs out. The casting mold obtained is fired and is then used as negative mold for metal casting.

In general, the precision casting process includes a substep in which a wax is injected into a tool which is the negative representation of the article to be produced. In this way, wax duplicates are produced as models of the article to be produced as positive. The following process steps serve to produce a refractory casting mold around the wax model. Substeps are dipping the wax model or many wax models adhesively bonded to a bar into a ceramic slurry, subsequent sanding, drying and repetition of these procedures until the desired layer thickness of the shell has been achieved. After drying the shell, the wax is then removed by heating. The casting mold is usually heated by means of pressurized steam in autoclaves so that the molten wax can flow out. Atmospheric-pressure processes using other heating methods are also known.

After removal of the wax, the ceramic is fired and thus hardened at high temperatures. Residues of the wax are also burnt before the metal is cast. It has to be ensured that all traces of the constituent of the wax formulation are removed from the ceramic casting mold in order to avoid defects on the metal casting.

As next step, molten metal or a metal alloy is cast into the hot casting mold. After cooling and solidification of the metal, the ceramic casting mold is removed from the object which has been cast. The raw casting then undergoes a further finishing process comprising patination, deflashing and removal of the sprues.

Problems in precision casting are possible when the wax of a specific wax formulation is injected into the tool. In general, the wax is injected at elevated temperature so that the wax flows into all cavities of the tool and fills it completely. Waxes are injected under pressure and thus become somewhat more fluid as a result of the shear. This makes it unnecessary to heat the wax formulation to such an extent that it has a sufficiently low viscosity to fill all cavities. If the wax formulation is injected into a tool having a complicated geometry and different thicknesses of the molding, the subregions having a greater thickness of the molding cool more slowly than those having a lower thickness of the molding. As a result, it is then found that the region having lower thicknesses of the molding are reproduced with greater dimensional accuracy. On the other hand, regions having higher thicknesses of the molding tend to have a relatively low accuracy of reproduction because of the higher shrinkage during the cooling process. Since the wax model is generally a one-to-one model of the metal casting to be produced, such inaccuracies carry over to the end product.

Furthermore, such different cooling rates and the different shrinkage between thin and thick parts of the molding result in considerable stresses in the wax model, which can cause deformation of the model when it is taken from the tool. In this way, the model attempts to dissipate the internal stresses.

A solution to increasing the accuracy of reproduction and stability of wax models has been achieved by addition of various fillers to the casting wax formulations. Examples are organic acids and inert polymers. For the present purposes, the expression filler refers to discrete, solid particles which do not melt during the lost wax process. Although the use of fillers has improved some properties of the precision casting wax formulations, it has not been able to solve some existing problems and has brought new problems with it.

Examples of various materials which have been proposed for use as fillers for precision casting wax formulations are water, isophthalic acid, terephthalic acid, bisphenol, poly-alpha-methylstyrene, crosslinked polystyrene and polyethylene terephthalate. Not all change all the relevant physical properties in the right direction. Thus, the polystyrene fillers described in U.S. Pat. No. 3,465,808 tend to result in the wax flowing out first on melting but the polystyrene filler remaining in the cavities, so that the casting mold tends to break open.

Organic fillers such as fumaric acid, adipic acid, isophthalic acid and terephthalic acid are likewise used. These generally have a high thermal conductivity. For this reason, the models made of such wax formulations cool quickly, as desired. The main disadvantage of the use of acidic fillers is the possibility of the acids reacting with constituents of the casting mold composition and thus adversely affecting the surface quality and the dimensional accuracy of the castings. Furthermore, the high thermal conductivity can result in the wax undergoing excessively rapid thermal expansion on melting and the shell of the casting mold therefore breaking (shell cracking).

Although inert, polymeric fillers do not react with constituents of the casting mold composition, they have a poor thermal conductivity and are difficult to remove from the casting mold during the dewaxing process. Significant ash residues therefore remain in the casting mold during burning of the residual material and these can then become noticeable as flaws on the surface of the casting.

Polystyrene, acrylic, polyurethane polymers are often used as inert polymeric fillers. The densities of these fillers are generally above 1 kg/dm³ and are generally significantly higher than the densities of the remaining components of a precision casting wax formulation.

It was an object of the invention to provide wax formulations for the precision casting process which contain novel fillers and do not display the abovementioned disadvantages such as poor sedimentation and thus also poor running-out behavior, high residual ash contents, thermal conductivity which is very different from the base wax and possible reaction of chemical groups with constituents of the casting mold composition.

This object has surprisingly been able to be achieved by a wax formulation which comprises a base formulation (b.) having a melting point of <100° C., preferably <80° C., and a wax powder or a wax powder mixture (a.) having a melting point above 120° C., preferably above 150° C., as filler.

The wax powders a.) do not melt at the usual use temperatures in model production, in particular also not during the dewaxing process.

The wax powders of the invention are eminently suitable as fillers for use in wax formulations for the precision casting process since they have very good compatibility with the base formulation of the wax formulation.

The wax formulation of the invention preferably contains the wax powder or the wax powder mixture a.) in a proportion of from 5 to 60% by weight, particularly preferably in a proportion of from 10 to 50% by weight, in particular in a proportion of from 25 to 40% by weight, based on the total wax formulation.

The constituents of the precision casting base formulations (without filler) known from the prior art usually melt in the range from 40° C. to 115° C., significantly below the softening point of the wax powders according to the invention.

The base formulations b.) are accordingly used in and matched to the precise field of use of the precision casting wax formulation in respect of melting point, viscosity, shrinkage and hardness using methods known to those skilled in the art.

Paraffins, resins or long-chain hydrocarbons are usually used as base formulation b.).

The base formulation b.) is preferably present in a proportion of from 50 to 95% by weight, based on the total wax formulation.

The wax powder a.) of the wax formulation of the invention has a melting point of greater than 120° C., preferably greater than 135° C., particularly preferably greater than 150° C.

Wax powders or wax powder mixtures a.) used according to the invention are by definition polyolefin waxes which are preferably, prepared from homopolymers of propylene or copolymers of propylene with ethylene or with one or more 1-olefins.

Particularly advantageous properties are found when the wax powder or the wax powder mixture a.) comprises a wax which has been prepared by polymerization of olefins, preferably propylene, in the presence of a metallocene as catalyst. The synthesis of metallocene polyolefin waxes can be carried out under a pressure of from 0.1 to 10 MPa in the gas phase or in suspension or in solution in a suitable suspension medium/solvent using known technologies.

Examples of metallocene polyolefin waxes which are preferably used as wax powder or wax powder mixtures as fillers in wax formulations are, for example:

Metallocene PP (polypropylene) waxes, e.g.:
TP Licocene® PP 6102
TP Licocene® PP 6502
TP Licocene® PP 7402
TP Licocene® PP 7502

In addition, the inventive wax formulations can also comprise further additives such as, for example, other polymers, resins or further fillers.

Suitable additives are, for example, petroleum waxes, natural vegetable or mineral waxes, synthetic waxes, polymers of monomers other than propylene and ethylene, resin-like materials obtained from the refining of petroleum or tree resin, hydrocarbon resins or terpene-like resins or mixtures of these or reaction products of fatty acids and polyfunctional diamines (e.g. ethylenediamine) (amide waxes) or similar materials.

Further suitable additives and fillers are: organic acids, polystyrene, crosslinked polystyrene, urea, polyacrylates, cellulose acetates, bisphenols, polyethylene terephthalate and high-melting polyols.

In a preferred embodiment, metallocene PP waxes are used as additives in proportions of from 0 to 50% by weight based on the total weight of the wax formulation. These serve, for example, to:
Increase or reduce the viscosity of the wax formulation
Increase the thermal and mechanical strength of the wax molding or/and
Reduce the thermal expansion (shrinkage)

The polypropylene waxes used as additive preferably have a melting point lower than that of the waxes a.), in particular a melting point of <110° C.

Examples of metallocene polyolefin waxes which can be used according to the invention as additive in the form of wax powders or wax granules in the wax formulations are, for example:

Metallocene PP waxes such as:
TP Licocene® PP 1302
TP Licocene® PP 1502
TP Licocene® PP 2602
TP Licocene® PP 3502

Examples of polyolefin waxes which can be used according to the invention as additive in the form of wax powders or wax granules in the wax formulations are, for example:
Licowax® PP 230
Ceridust® 6071

Examples of reaction products of fatty acids and polyfunctional diamines (amide waxes) which can be used according to the invention as additive in the form of wax powders or wax granules in the wax formulations are, for example:
Ethylenebisstearamides
Licowax® C

Manufacturer of the abovementioned waxes is Clariant Produkte (Deutschland) GmbH.

Metallocene catalysts for preparing the polyolefin waxes are preferably chiral or achiral transition metal compounds of the formula M¹Lₓ. The transition metal compound M¹Lₓ comprises at least one central metal atom M¹ to which at least one π ligand, e.g. a cyclopentadienyl ligand, is bound. In addition, substituents such as halogen, alkyl, alkoxy or aryl groups can be bound to the central metal atom M1. M¹ is preferably an element of main group III, IV, V or VI of the Periodic Table of the Elements, e.g. Ti, Zr or Hf.

For the purposes of the present invention, cyclopentadienyl ligands are unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π ligands can be bridged or unbridged, with simple and multiple bridges, including via ring systems, being possible. The term metallocene also encompasses compounds having more than one metallocene fragment, known as multinucleometallocenes. These can have any substitution pattern and bridging variants. The individual metallocene fragments of such multinucleometallocenes can be either identical or different from one another. Examples of such multinucleometallocenes are, for example, described in EP-A-0 632 063.

Examples of general structural formulae of metallocenes and of their activation by means of a cocatalyst are given, inter alia, in EP-A-0 571 882.

The wax formulation of the invention surprisingly has a very good thermal expansion behavior and also a very good accuracy of reproduction and dimensional stability of the positive model.

Since the waxes a.) used according to the invention do not contain any reactive chemical groups and are therefore chemically inert, no reaction takes place with the constituents of the commercial casting mold compositions, which is advantageous with regard to the surface quality and the dimensional accuracy of the castings.

The waxes described display very good compatibility with the base formulations of the wax formulation. This is reflected in very good wetting of the wax powder a.) by the molten constituent of a precision casting wax formulation.

The very similar densities of the waxes a.) and the base formulation b.) guarantees that the filler a.) has little tendency to sediment. This is reflected in a very stable suspension.

Owing to the small coefficients of thermal expansion, the good thermal behavior of the wax powders on heating during the dewaxing process prevents breakage of the ceramic shells (shell cracking). The required combustion without leaving a residue of the wax residues which have not flowed out after the dewaxing process is improved by the very low residual ash content of the wax powder a.), so that a particularly good surface quality of the castings is achieved.

The wax powder a.) according to the invention is produced by milling. Here, 90% of the wax powder particles have a diameter below 250 μm, preferably below 200 μm, particularly preferably below 150 μm, and at least 50% of the particles have a diameter below 150 μm, preferably below 100 μm, particularly preferably below 75 μm.

The wax powders a.) have a density at 20° C. of from 0.85 to 1.20 g/cm³, preferably from 0.87 to 0.97 g/cm³, particularly preferably from 0.87 to 0.92 g/cm³.

The wax formulation of the invention is made into plates, granular material, flocks or other customary use forms.

The wax powder fillers a.) can be filtered off from the molten wax formulation. This allows recycling of the waxes, leading to considerable material and cost savings in the precision casting process.

The wax formulations of the invention have the great advantage that they do not adhere to the interior walls of the ceramic shells during dewaxing, which leads to high recovery rates and high surface qualities of the castings.

The temperatures in the dewaxing process are usually in the range from 140° C. to 180° C. After dewaxing, the ceramic mold is fired at temperatures above 600° C. The constituents of the wax formulation which have not run out (residual wax in the ceramic mold) burn.

The wax formulations of the invention have a low residual ash content. After burning of the residues, usually less than 0.02% by weight of the mixture remains in the ceramic mold. The wax powder (filler) burns to leave virtually no residue.

Furthermore, it is ecologically advantageous that the wax powders a.) used are not hazardous materials and are not harmful to health.

The invention is illustrated by the examples below without being restricted thereto.

### EXAMPLES

In the examples below, the following waxes a.) are used in powder form as fillers in the precision casting wax formulations:

Metallocene PP waxes
TP Licocene® PP 6102
TP Licocene® PP 6502
TP Licocene® PP 7402
TP Licocene® PP 7502

As additives, the following waxes were used

Metallocene PP waxes such as:
TP Licocene® PP 1302
TP Licocene® PP 1502
TP Licocene® PP 2602
TP Licocene® PP 3502

Polyolefin waxes such as:
Licowax® PP 230
Ceridust® 6721

Reaction products of fatty acids and polyfunctional diamines (amide waxes) such as:
Ethylenebisstearamide
Licowax® C

Manufacturer of the abovementioned waxes is Clariant Produkte (Deutschland) GmbH.

### Example 1

A wax powder a.) was produced by milling granules of TP Licocene® PP 6102.

The material is characterized by a dropping point of about 145° C. and a dynamic viscosity of 60 mPas at 170° C. Mechanical tests on standard test specimens gave the following measured values:
Needle penetration: <1

The resulting powder which is used as filler for the precision casting wax formulations has the following particle size distribution: 90% of the particles have a diameter below 150 μm and 50% of the particles have a diameter below 75 μm.

### Example 2

A wax powder was produced by milling granules of TP Licocene® PP 7402. The material is characterized by a softening point of about 165° C. and a dynamic viscosity of 800 mPas at 170° C. Mechanical tests on standard test specimens gave the following measured values:
Needle penetration: <1

The resulting powder which is used as filler for the precision casting wax formulations has the following particle size distribution: 90% of the particles have a diameter below 250 μm and 50% of the particles have a diameter below 75 μm.

### Example 3

A wax powder was produced by milling granules of TP Licocene® PP 7502. The material is characterized by a softening point of about 165° C. and a dynamic viscosity of 1800 mPas at 170° C. Mechanical tests on standard test specimens gave the following measured values:
Needle penetration: <1

The resulting powder which is used as filler for the precision casting wax formulations has the following particle size distribution: 90% of the particles have a diameter below 250 μm and 50% of the particles have a diameter below 75 μm.

### Example 4

A precision casting wax formulation was produced from the following components:
60% of Paraffin 60/62 (base wax b.)
25% of TP Licocene® PP 7402 (milled) (filler a.)
15% of TP Licocene® PP 3502 (additive)

The precision casting wax formulation is characterized by a dropping point of about 83° C. and a dynamic viscosity of about 33 mPas at 100° C. (about 60 mPas at 90° C.). Mechanical tests on standard test specimens gave the following measured values:

| | |
|---|---|
| Needle penetration: | about 5 |
| Density: | about 0.91 kg/dm³ |
| Solidification: | at about 60° C. |

### Example 5

A precision casting wax formulation was produced from the following components:
60% of Paraffin 60/62 (base wax b.)
25% of TP Licocene® PP 7502 (milled) (filler a.)
15% of TP Licocene® PP 3502 (additive)

The precision casting wax formulation is characterized by a dropping point of about 81° C. and a dynamic viscosity of about 33 mPas at 100° C. (about 60 mPas at 90° C.). Mechanical tests on standard test specimens gave the following measured values:

| | |
|---|---|
| Needle penetration: | about 8 |
| Density: | about 0.91 kg/dm³ |
| Solidification: | at about 60° C. |

### Example 6

A precision casting wax formulation was produced from the following components:
60% of Paraffin 60/62 (base wax b.)
25% of TP Licowax® PP 230 (milled) (filler a.)
15% of TP Licocene® PP 3502 (additive)

The precision casting wax formulation is characterized by a dropping point of about 115° C. and a dynamic viscosity of about 250 mPas at 100° C. (about 310 mPas at 90° C.). Mechanical tests on standard test specimens gave the following measured values:

| | |
|---|---|
| Needle penetration: | about 10 |
| Density: | about 0.71 kg/dm³ |
| Solidification: | at about 68° C. |

### Example 7

A precision casting wax formulation was produced from the following components:
60% of Paraffin 60/62 (base wax b.)
25% of TP Ceridust® 6071 (milled) (filler a.)
15% of TP Licocene® PP 3502 (additive)

The precision casting wax formulation is characterized by a dropping point of about 89° C. and a dynamic viscosity of about 490 mPas at 100° C. (about 600 mPas at 90° C.). Mechanical tests on standard test specimens gave the following measured values:

| | |
|---|---|
| Needle penetration: | about 9 |
| Density: | about 0.85 kg/dm³ |
| Solidification: | at about 105° C. |

### Example 8

A precision casting wax formulation was produced from the following components:
60% of Paraffin 60/62 (base wax b.)
25% of Ethylenebisstearamide (milled) (filler a.)
15% of TP Licocene® PP 3502 (additive)

The precision casting wax formulation is characterized by a dropping point of about 88° C. and a dynamic viscosity of about 775 mPas at 100° C. (about 950 mPas at 90° C.). Mechanical tests on standard test specimens gave the following measured values:

| | |
|---|---|
| Needle penetration: | about 11 |
| Density: | about 0.95 kg/dm³ |
| Solidification: | at about 72° C. |

1. A wax formulation comprising
a.) a wax powder or a wax powder mixture having a melting point above 120° C. as filler and
b.) a base formulation having a melting point below 100° C.

2. The wax formulation as claimed in claim 1, wherein the wax powder or wax powder mixture a.) is present in a proportion of from 5 to 60% by weight and the base formulation b.) is present in a proportion of from 50 to 95% by weight, based on the total wax formulation.

3. The wax formulation as claimed in claim 1, wherein the wax powder or a wax powder mixture a.) is a polyolefin wax prepared by polymerization of olefins in the presence of one or more metallocene as catalyst.

4. The wax formulation as claimed in claim 3, wherein the one or more metallocene catalysts comprise chiral or achiral transition metal compounds of the formula M¹Lₓ.

5. The wax formulation as claimed in claim 1, wherein the wax powder or a wax powder mixture a.) is selected from the group consisting of TP Licocene® PP 6102, TP Licocene® PP 6502, TP Licocene® PP 7402 TP Licocene® PP 7502 and mixtures thereof.

6. The wax formulation as claimed in claim 1, wherein the wax formulation comprises from 5 to 60 parts by weight of wax powder or a wax powder mixture a.) and from 40 to 95% by weight of at least one additive, based on the total wax formulation.

7. The wax formulation as claimed in claim 6, wherein the at least one additive is selected from the group consisting of metallocene PP waxes, polyolefin waxes or reaction products of fatty acids and polyfunctional diamines or or a mixture thereof.

8. The wax formulation as claimed in claim 6, wherein the at least one additive is selected from the group consisting of petroleum waxes, natural vegetable or mineral waxes, synthetic waxes, polymers of monomers other than propylene and ethylene, resin-like materials derived from the refining of petroleum or tree resin, hydrocarbon resins or terpene-like resins or a mixture thereof.

9. The wax formulation as claimed in claim 1, further comprising one or more compounds selected from the group consisting of organic acids, polystyrene, crosslinked polystyrene, urea, polyacrylates, cellulose acetates, bisphenols, polyethylene terephthalate and high-melting polyols.

10. The wax formulation as claimed in claim 6, wherein the at least one additive is selected from the group consisting of TP Licocene® PP 1302, TP Licocene® PP 1502, TP Licocene® PP 2602, TP Licocene® PP 3502 and mixtures thereof.

11. The wax formulation as claimed in claim 1, wherein 90% of the wax powder or wax powder mixture particles a.) have a diameter below 250 μm and at least 50% of the wax powder or wax powder mixture particles have a diameter below 150 μm.

12. The wax formulation as claimed in at least one of the preceding claims, wherein the wax powder or wax powder mixture a.) has a density at 20° C. of from 0.85 to 1.20 g/cm³.

13. A precision cast article produced using a wax formulation as claimed in claim 1.
